(19) United States
(12) Patent Application Publication
(10) Pub. No.: US 2004/0116610 A1
(43) Pub. Date: Jun. 17, 2004

(54) Copolymers based on grafted olefins and method for obtaining same

(76) Inventors: Nadia Torres, Montpellier (FR); Cedric Loubat, Montpellier (FR); Jean-Jacques Robin, Clapiers (FR); Bernard Boutevin, Montpellier (FR)

Correspondence Address: Edwards & Angell, PO Box 9169, Boston, MA, 02209, US

(21) Appl. No.: 10/451,231

(22) PCT Filed: Dec. 21, 2001
(86) PCT No.: PCT/FR01/04145

(30) Foreign Application Priority Data
Dec. 22, 2000 (FR) 00/16927

(51) Int. Cl. C08F 261/02; C08F 261/10; C08F 279/00

(52) U.S. Cl. 525/242; 525/298; 525/313

(57) ABSTRACT

Olefin-based copolymers made affine by grafting, characterised in that they are composed of:

i) at least one polyolefin functionalised with reactive functions of an appropriate type and in controlled number;

ii) and at least one mono-functional type oligomer with a predetermined chain length, a low polydispersity index and an absolutly controlled structure, which is grafted on the functionalised polyolefin by means of reactive functions.

These copolymers made affine by grafting are designed to be placed in intimate contact with materials of non-olefinic or olefinic composition with which the copolymers were not initially compatible.

### FIELD OF THE INVENTION

The invention relates to olefin-based copolymers made affine with regard to the materials with which they are brought in intimate contact by grafting.

The invention relates to the graft used for grafting the functionalised polyolefin and for obtaining the olefin-based copolymer, made affine by grafting.

The invention also relates to the method of preparing the graft used for grafting the functionalised polyolefin and for obtaining the olefin-based copolymer made affine by grafting.

Finally, the invention relates to the use of olefin-based copolymers made affine by grafting for use with or in intimate contact with materials with an olefinic or non-olefinic composition.

The term “affine” is defined as being the capacity of copolymers according to the invention to bond to materials with an olefinic or a non-olefinic composition, and thus even materials without any affinity with each other, such as other thermoplastic polymers, metals, wood, when the said copolymer is used with one of these materials, for example in extrusion, coextrusion, lamination, extrusion-coating or covering.

### STATE OF THE ART

Well known thermoplastic polymers are usually used in many fields of application depending on their specific inherent characteristics.

However, technological progress and the demand for new materials are such that they are pushing the application -limits of polymers alone and/or specific copolymers, to create new fields of application dealing with mixing or bringing into contact polymer materials that were initially incompatible with each other, but that have been made compatible by appropriate means, for these new application fields.

The need then arose to be able to make these various polymers useable with each other, for example in the form of different mixtures of powders, bonding treatments or bounding assemblies, by the creation of a mutual affinity: this need to create compatibility between two materials that are not naturally compatible, is the source of many means of creating compatibility, including one particular means that consists of creating reactive functions on a polymer that does not have these functions naturally, and using created reactive functions to graft functional compounds such as monomers or oligomers onto this polymer.

In particular, thermoplastic olefinic polymers that have excellent qualities and behaviours in many different application fields, for example such as injection, extrusion, coextrusion, extrusion-coating, and that are used industrially in a wide variety of fields, for example such as means of transport, space, electricity, electrotechnical, electronics, construction of sports facilities, health and medical products, food, particularly through barrier films, the non-woven, have to be preferably associated with other materials such as non-olefinic polymers (polyamide, polyesters, polycarbonates or others), metallic materials, wood, or may themselves receive a film forming covering for example such as a paint.

Thermoplastic olefinic polymers are non polar materials that have a very weak affinity with regard to other materials with which they can come into intimate contact, particularly with regard to polar type polymers, for example such as polyamides, polyesters, polycarbonates, polystyrene and polyvinyl chloride, and also with regard to other polyolefins, wood, metals and others.

This is why in practice, the use of an olefinic polymer in combination with another thermoplastic polymer, and particularly with polar polymers, was found to be difficult due to:

heterogeneities, for example, created within the final material when an obviously heterogeneous molten mix is being used, which have an influence on the mechanical performances of the product obtained,

or for example, the bad bond of one of the polymers with the other polymer when the objective is to bring two surfaces, such as two films, together.

So, research work on olefinic polymers has increased to achieve at least some compatibility with regard to other materials with a non-olefinic or olefinic composition, for example either to enable extrusion of a mixture of two initially incompatible polymers, one of which is a polyolefin, or to create a bond between two polymer surfaces of incompatible compositions obtained by coextrusion or held together by hot-melt and lamination, or to successfully achieve an extrusion-coating, or for any other envisaged application.

Particularly efficient approaches have become clear as a result of this large amount of work, which consist of chemically modifying the structure of the olefinic polymer by functionalising it, and then grafting chemical compounds such as polar polymerisable monomers or monomers carrying reactive functions, onto the functionalised olefinic polymer.

Firstly, state of the art methods concern the functionalisation of olefinic polymers. Two approaches among these methods are particularly attractive for producing polyolefins with reactive sites that can subsequently be grafted by means of polar or reactive chemical compounds:

one of these methods consists of modifying the structure of the olefinic polymer by functionalising it by creating reactive sites or sites with a polar nature on the molecule;

the other of these approaches consists of producing a statistical olefinic copolymer using at least two monomers, one of which is olefinic, for example such as ethylene, and the other has a polar nature such as maleic anhydride or glycidyl methacrylate.

Once the polyolefins have been functionalised, they can be used to make polymers compatible or they can be grafted according to an appropriate process using grafts that are themselves functional monomers having the capacity of polymerising and/or functional oligomers.

According to a first type of grafting, the process consists of grafting a functional polymerisable monomer onto a non-functionalised polyolefin. This type of process is described in Japanese patents No. 70-030943 and 59-149940, in the work done by G. H. Hu et al. (described in, “Reactive Modifiers for Polymers” first edition, Blackie Academic & Professional an Imprint of Chapman et al., London 1997, chapter 1, p. 1-97), in work done by K. MATYJASZEWSKI et al (described in <<GRAFT COPOLYMERS OF POLYETHYLENE BY ATOM TRANSFER RADICAL POLYMERISATION>> published in <<JOURNAL OF POLYMER SCIENCE>>, pages 2440 to 2448-22 June 2000), in the work done by Y. MIWA et al (described in <<LIVING RADICAL GRAFT POLYMERIZATION OF STYRENE TO POLYPROPYLENE . . . >> published in <<MACROMOLECULES AMERICAN CHEMICAL SOCIETY>>. EASTON US Vol. 32, NR. 24, pages 8234 to 8236) in which the grafted copolymers used to make mixtures of incompatible polymers compatible with each other, are obtained by grafting the monomer on the activated polyolefin. In this case, a propylene homopolymer or an ethylene-propylene copolymer can be grafted by means of maleic anhydride, the grafted polymer and/or copolymer being intended for use in a polymers composition in which the other constituents are polypropylene and a polyamide that are not compatible with each other.

This first type of process using grafting of a monomer on an activated polyolefin, although it actually produces a grafted olefinic copolymer, made compatible with other polymers that are initially incompatible, is accompanied by uncontrolled secondary phenomena that are undesired and seriously disturb the making of the compatibility of said grafted polyolefins.

These uncontrolled secondary phenomena of the mentioned process that become genuine disadvantages, are:

a low and uncontrolled functionalisation rate of the polyolefin, causing a lack of control of the number of functional grafts subsequently fixed on the functionalised polyolefin;

a lack of control over the length of functional grafts for which the molecular weights may have a high dispersion from one graft to another, due to the use of a functional monomer that can react in its existing state with active sites of the functionalised polyolefin, or that can react firstly with itself, thus causing the formation of a homopolymer;

an incomplete grafting of the functionalised polyolefin due to the very reactive nature of the monomer that preferably forms homopolymer molecules to the detriment of a reaction with reactive sites (less reactive) of the functionalised polyolefin;

the partial cross-linking of the incompletely grafted functionalised polyolefin through its reactive sites that have not reacted with the monomer.

According to a second type of grafting, the process consists of grafting a functional oligomer on a functionalised polyolefin. For example, this type of process is described in U.S. Pat. No. 5,342,886 or in the Japanese patent 60-233131.

In the first document (U.S. Pat. No. 5,342,886), the oligomers grafted on the polyolefins are prepared by polycondensation of a monomer with two compatible reactive functions at the ends, the polycondensation being made by chemical reaction and not by polymerisation. It is very difficult to produce mono-functional oligomers with this preparation method. Furthermore, their use is limited to polyolefin-polycondensate mixture, although it would be desirable for it to concern all types of mixtures.

In the second document (JP60-233131), the oligomers grafted on the functionalised polyolefins are prepared by radicalar polymerisation, but the method of grafting on the functionalised polyolefin is made in a solvent medium that may be xylene or monochlorobenzene, causing many disadvantages during and after the grafting reaction. These disadvantages may include, for example:

the necessity of carrying out the grafted copolymer synthesis in several steps;

the fact that it is impossible to completely eliminate the solvent after the grafting operation, and the presence of the solvent within the grafted copolymer may cause uncontrolled secondary effects when the grafted olefinic copolymer is brought into intimate contact with another material, particularly with a polymer initially incompatible with the polyolefins, such as polyamides, polyesters, polycarbonate, or others;

the impossibility of continuous grafting, since the grafting reaction in a solvent medium must be conducted until its completion after components have been added and until the solvent has been eliminated, necessitating that the grafting reaction takes place according to precise quantities of the various components, those quantities cannot change without causing certain damage to the required grafted copolymer;

the impossibility of transforming the grafting mode in a solvent medium into an efficient, time saving, reproducible industrial process that produces a copolymer without impurities consisting of traces of solvents.

According to a third type of grafting (EP0955317), the process for obtaining a grafted copolymer consists of forming it by chemical reaction by inserting a reactive agent between two different polymer chains of which each end is provided with a reactive function (for example —COOH),which also has at each of its ends a reactive function (for example —NH₂) that can react chemically with the reactive functions present at the ends of the two chains of polymers. But this process is apparently only intended for preparation of a very particular grafted copolymer.

### PURPOSE OF THE INVENTION

The invention is intended not only to eliminate all the disadvantages with the state of the art, but also to provide improvements to copolymers based on grafted olefins, to make them particularly attractive in their subsequent applications with other materials with which they are made affine.

A first purpose of the invention is to:

have a number of active sites well controlled, in other words predetermined and actually obtained, on the previously functionalised and commercial polyolefin, or

to create these sites on the polyolefin to be functionalised.

Another purpose of the invention is to graft a well controlled number of grafts on the functionalised polyolefin.

Another purpose of the invention is to graft oligomer grafts onto the functionalised polyolefin, these grafts being oligomers with a predetermined and controlled chain length, in other words with approximately the same molecular weight for each molecule since they are prepared under conditions leading to a very low molecular polydispersity index.

Another purpose of the invention is to be able to graft several oligomers with different compositions on the activated polyolefin.

Another purpose of the invention is to use mono-functional oligomers for grafting functionalised polyolefins.

Another purpose of the invention is to produce olefin-based copolymers made affine by grafting, that are free of solvents.

Another purpose of the invention is to create, from functionalised polyolefins, olefin-based copolymers made affine by grafting oligomers with a controlled composition and architecture, produced in accordance with the requirements of the potential user.

Another purpose of the invention is to make olefinic copolymers made affine by grafting in a single step, in installations that can be on an industrial scale, within a very short period and with an excellent continuity in the production of the said copolymers.

The final purpose of the invention is to produce olefinic copolymers made affine by grafting, that are not polluted by the formation of compounds originating from uncontrolled secondary reactions during the grafting.

### SUMMARY OF THE INVENTION

According to the various purposes of the invention mentioned above, the olefin-based copolymers made affine by grafting eliminate the disadvantages that appear through an examination of the state of the art, and also provide many substantial improvements that did not exist in means described up to now, to make these grafted olefinic copolymers particularly affine with regard to materials with non olefinic or olefinic composition with which they will come into intimate contact.

According to the invention, olefin-based copolymers made affine by grafting are characterised in that they are composed of:

i) at least one polyolefin functionalised by means of reactive functions of an appropriate type and in controlled number;

ii) and at least one mono-functional type oligomer with a predetermined chain length, with a very low polydispersity and a controlled structure which is grafted on the functionalised polyolefin by means of reactive functions, this oligomer being formed from polymerisable monomer(s) and by an approach other than polycondensation.

Also according to the invention, the olefin-based copolymers made affine by grafting with regard to other materials with a non olefinic or olefinic composition into which they come into intimate contact, are characterised in that:

i) a polyolefin functionalised by means of an appropriate type and controlled number of reactive or polar functions is used;

ii) the reactive sites of the functionalised polyolefin are made to react at the necessary temperature with at least one mono-functional type oligomer with a predetermined chain length, a low polydispersity index and with an absolutely controlled structure, this oligomer being formed from polymerisable monomer(s) and by an approach other than polycondensation.

Also according to the invention, the olefin-based copolymers grafted to make them affine with regard to other materials of non-olefinic or olefinic composition with which they will come into intimate contact, are characterised in that they are obtained using the process consisting of:

i) using a polyolefin functionalised by means of an appropriate type and a controlled number of reactive or polar functions;

ii) making to react the reactive sites of the functionalised polyolefin at the necessary temperature with at least one mono-functional type oligomer with a predetermined chain length, a low polydispersity index and with an absolutely controlled structure, this oligomer being formed from polymerisable monomer(s) and by an approach other than polycondensation;

iii) bringing the grafted copolymer into intimate contact with the material with a non-olefinic or olefinic composition using an appropriate means.

### DETAILED DESCRIPTION OF THE INVENTION

Olefin-based copolymers grafted according to the invention are grafted by the reaction of a functionalised polyolefin with at least one mono-functional type oligomer for which the monomer is polymerisable, with a predetermined and controlled molecular chain length, with a very low polydispersity index and a predetermined structure, in other words that is defined in advance and obtained as defined. These grafted olefin-based copolymers are ideally suited to satisfying the requirements of each need to be satisfied and are not polluted by the presence of materials usually resulting from unwanted secondary reactions such as the reaction that occurs during functionalisation, particularly the formation of homopolymers, block copolymers, cross linking products or others.

According to the invention, the polyolefins to be functionalised that will be grafted can be obtained by one of the following functionalisation methods:

functionalisation by direct grafting,

or functionalisation by copolymerisation.

Functionalisation by Direct Grafting

According to the first approach that consists of functionalising polyolefins by direct grafting, the polyolefins to be functionalised are preferably chosen from the group composed of low density polyethylene, linear low density polyethylene, ultra low density polyethylene, high density polyethylene, high density and high molecular weight polyethylene, high density and ultra high molecular weight polyethylene, medium density polyethylene, metallocene polyethylene, polyisobutylene, polybut-1-ene, poly-4-methylpentene, polyisoprene, polybutadiene, cycloolefins for example such as cyclopentene or norbornene, polypropylene, ethylene-propylene copolymers, ethylene and α-olefin in C₄ to C₁₀ copolymers, propylene and α-olefin in C₄ to C₁₀ copolymers, elastomeric olefin copolymers such as ethylene-propylene-diene, rubber ethylene-propylene copolymers, vinyl acetate-ethylene copolymers, a mixture of a copolymer with a polymer such as for example polypropylene/ethylene-propylene copolymer, low density polyethylene/vinyl acetate copolymer.

According to this first approach, the polyolefins are functionalised by direct grafting by means of an appropriate monomer with a double bond

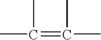

that provides at least one reactive function, the functionalisation being done in the presence of a radicalar trigger or being done on activated polyolefins.

The appropriate monomer, which provides at least one reactive function, is then chosen in the group composed of monomers provided with a double bond and having at least one reactive function, for example of the acid, hydroxyl, anhydride, epoxy, amine, oxazoline, isocyanate or az-lactone type.

Some of the most frequently used monomers that provide the reactive function are mentioned below for illustrative purposes, without being in any way limitative:

for the:

acid function: acrylic acid or methacrylic acid or any other unsaturated acid capable of polymerising or copolymerising by grafting;

hydroxyl function: hydroxyethyl methacrylate or hydroxymethyl methacrylate or hydroxypropyl methacrylate or hydroxyethyl acrylate or hydroxymethyl acrylate or hydroxypropyl acrylate.

epoxy function: glycidyl methacrylate or glycidyl acrylate;

anhydride function: maleic anhydride or itaconic anhydride or citraconic anhydride or tetrahydrophthalic anhydride and mixes of these anhydrides;

oxazoline function: vinyloxazoline;

monoisocyanate function:

m-isopropenyl, dimethyl benzyl isocyanate (TMI) with formula H₂C═C(CH₃)C₆H₄—C(CH₃)₂—NCO

methacryloyl isocyanate (MAI) with formula H₂C═C(CH₃)—CONCO

adduct obtained from hydroxyethyl acrylate of formula H₂C═CHCO₂(CH₂)₂—OH and pure 2.4-diisocyanate toluene (TDI) of formula H₃C—C₆H₃(NCO)₂ or any other diisocyanate

az-lactone function: vinylaz-lactone in which the R₁ and R₂ groups may be a fluorided or unfluorided alkyl chain and R₃ group is a vinyl group or any other polymerisable group.

amine function: allylarmine H₂C═CHCH2—NH₂

derivatives of acrylamide such as N-(hydroxymethyl) acrylamide with formula H₂C═CH—CON—H—CH₂—OH

When the functionalisation is done by direct grafting in the presence of a radicalar trigger, this trigger may be chosen for example from the group composed of bisazoic compounds, peroxides, hydroperoxides, peresters.

But when the functionalisation is done on activated polyolefins, they may be activated by known means such as for example ozonisation, ultraviolet radiation, plasma, CORONA effect or irradiation by radiation of electrons or gamma radiation.

The functionalisation of polyolefins by the previously mentioned chemical functions can be done:

either by direct grafting in the presence of a radicalar trigger;

or by prior activation of them,

and is carried out in a molten medium, in a discontinuous or continuous mixer, or in a single screw or preferably dual screw extruder provided with a degassing zone, by adding the various components involved in functionalisation of the polyolefin.

Depending on which of these methods is used for the functionalisation of the polyolefins, the functionalisation rate is comprised in the range from 0.1 to 60% by weight of monomer contained in the polyolefin.

Functionalisation by Copolymerisation

According to the second type of functionalisation, the polyolefins to be functionalised are functionalised by copolymerisation of an olefinic monomer and at least one monomer carrying a double bond

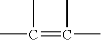

and a reactive function, under conventional copolymerisation conditions.

The most frequently marketed functionalised polyolefins are mentioned as non-limitative illustrations. They are the following copolymers of

ethylene and glycidyl methacrylate, ethylene and methyl or ethyl acrylate and glycidyl methacrylate with contents in glycidyl methacrylate of 1 to 8% by weight;

ethylene and butyl acrylate and glycidyl methacrylate containing 5% by weight of glycidyl methacrylate;

ethylene and methyl or ethyl acrylate and maleic anhydride with contents in maleic anhydride not exceeding 3.5% by weight;

ethylene and acrylic acid neutralised by cations (surlyn);

ethylene and vinyl acetate;

copolymers with blocks of the styrene-ethylene-butylene-styrene type, maleic anhydride functionalised;

the olefinic monomer and the monomer carrying the reactive function can be copolymerised with or without the presence of a comonomer of acrylic ester type.

According to this functionalisation mode, the functionalisation rate of the statistical copolymer is adjusted by the content in comonomer(s) that can preferably vary from 3 to 50% by weight.

An olefinic monomer and a monomer carrying the appropriate reactive function are functionalised by copolymerisation according to processes and technologies used in techniques for obtaining olefin-based copolymers.

In each of the polyolefins functionalisation approaches by direct grafting or by copolymerisation, the creation of a determined and controlled number of active sites in the polyolefins structure is important for the affine character of the copolymers grafted according to the invention, when it is important to control the number of grafts when bringing said grafted copolymers into intimate contact with a material of non-olefinic or olefinic composition.

Preparation of the Graft According to the Invention: Mono-Functional Oligomer

One of the purposes of the invention is to graft mono-functional oligomer grafts onto functionalised polyolefins, these grafts having a predetermined chain length and controlled by a very low molecular polydispersity index, these oligomers being formed from polymerisable monomer(s) and by an approach other than polycondensation.

The choice of the mono-functional oligomer for the grafting of the functionalised polyolefin is a result of the observed fact that using a multi-functional oligomer for said grafting produces approximately the same effects as using a polymerisable functional monomer. Uncontrolled and particularly inconvenient secondary phenomena occur during the grafting operation of the functionalised polyolefin strongly disturbing the creation of the affine character of the functionalised and grafted polyolefin, in other words of the olefinic copolymer grafted according to the invention, with regard to other incompatible materials of non-olefinic or olefinic composition.

Among the observed and uncontrollable secondary phenomena that are genuine disadvantages, there are risks of cross-linking of the polyolefin chains between themselves through multifunctional oligomers, and this cross-linking can cause the creation of a network making the cross-linked material unmeltable and insoluble.

Thus, the graft used according to the invention to obtain a grafted olefin-based copolymer, made affine with regard to non-olefinic or olefinic materials, is a mono-functional oligomer:

with a predetermined chain length,

with very low polydispersity index,

with a well-defined structure.

This mono-functional oligomer according to the invention comprises a reactive function that must be compatible with the reactive function of the functionalised polyolefin.

This compatibility between the reactive functions of the functionalised polyolefin and the mono-functional oligomer to be grafted is acquired when the correspondence between the reactive functions on each of the carriers concerned complies with the list given in table I.

TABLE I
of simultaneously present compatible functions

| | on the mono-functional oligomer used for |
|---|---|
| on the functionalised polyolefin | grafting the functionalised polyolefin |
| acid: —COOH (1) | hydroxyl (2) or epoxy or oxazoline or amine (4) |
| | or isocyanate (3) |
| anhydride: for | hydroxyl (2) or amine (4) |
| example maleic | |
| 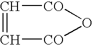 | |
| hydroxyl: —OH (2) | acid (1) or anhydride or isocyanate (3) or az- |
| | lactone |
| | 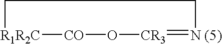 |
| epoxy | acid (1) or hydroxyl (2) or amine (4) |
| 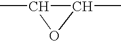 | |
| oxazoline | acid (1) or anhydride |
| 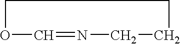 | |
| isocyanate —NCO (3) | Hydroxyl (2) or amine (4) or acid (1) |
| amine NH₂ (4) | Hydroxyl (2) or anhydride or isocyanate (3) or |
| | az-lactone (5) |
| Az-lactone (5) | Hydroxyl (2) or amine (4) |

(1) —COOH: mono, di or tri-acid

(2) —OH: mono, di or trihydroxyl

(3) —NCO: mono

(4) —NH₂: primary or secondary

(5) az-lactone: az-lactone vinyl in which the R₁ and R₂ groups may be a fluorided or unfluorided alkyl chain and R₃ group is a vinyl group or any other polymerisable group.

The mono-functional oligomer according to the invention preferably originates from an acrylic, methacrylic, vinylic, styrenic, dienic structure, each stated structure comprising one of the reactive functions compatible with the reactive function of the functionalised polyolefin and realized from polymerisable monomers originating from these structural families.

The mono-functional oligomer according to the invention forming the graft intended for grafting a functionalised polyolefin to create a polyolefin-based grafted affine copolymer, comprising simultaneously the three characteristics mentioned above, in other words:

have a predetermined and controlled chain length;

have very low polydispersity index;

maintain a well-defined structure;

can be obtained with these three characteristics simultaneously by one of the processes selected among those using a:

redox or radicalar telomerisation method,

or a controlled radicalar polymerisation method.

According to the telomerisation method, a polymerisable monomer M, comprising a function compatible with the reactive sites of the functionalised polyolefin, is treated by means of a transfer agent XY (called telogen). The reaction between the monomer and the transfer agent leads to a telomer of the type:

X—(M)ₙ—Y

The degrees of polymerisation of the telomers obtained are low, usually less than 100, and controllable.

According to a first approach, the telomerisation may be done by redox catalysis, triggered particularly by transition metals or their salts ,such as those of iron or copper FeCL₃/benzoin or CuCL₂.

According to a second approach, the telomerisation may have a radicalar nature, the reaction between the monomer and the transfer agent being triggered by free radicals resulting from a thermal or photochemical decomposition.

This second radicalar telomerisation approach is preferably used according to the invention since, unlike telomerisation by redox catalysis, it is a means of obtaining a mono-functional telomer that can very easily be purified since it is free of metallic compounds.

A non-limitative illustration of these approaches can be given by mentioning a few cases of preparation of mono-functional oligomers using the radicalar telomerisation method.

Thus, a mono-functional acrylic or methacrylic telomer with an acid function can be obtained by radicalar telomerisation of butyl acrylate or methyl methacrylate by thioglycolic acid triggered by 2,2′ azo bis iso butyronitrile (AIBN) and a mono-functional acrylic or methacrylic telomer with an alcohol function can be obtained by radicalar telomerisation of butyl acrylate or methyl methacrylate by mercapto-ethanol triggered by AIBN.

Similarly, a mono-functional styrenic telomer with an acid function may be obtained by radicalar telomerisation of styrene by trifluoroacetic acid triggered by AIBN.

Similarly, a mono-functional vinylic telomer with an acid function can be obtained by radicalar telomerisation of vinyl acetate by trifluoroacetic acid triggered by AIBN and a mono-fundtional vinylic telomer with an alcohol function may be obtained by radicalar telomerisation (TR) of vinyl acetate by trichloro-ethanol triggered by AIBN.

Similarly, a mono-functional dienic telomer with an acid function can be obtained by radicalar telomerisation of butadiene by trifluoroacetic acid triggered by AIBN.

The mono-functional oligomer obtained by telomerisation, and particularly radicalar telomerisation, has a molar mass of between 200 g/mole and 10 000 g/mole as determined by the [telogen]/[functional monomer] concentration ratio, with a polydispersity index given by the ratio \overline{Mw}/\overline{Mn} where \overline{Mw} is the average molecular mass by weight and \overline{Mn} is the average molecular mass by number, comprised between 1.5 and 2, but always inferior to 2 and preferably comprised between 1.4and 1.6.

According to the controlled radicalar polymerisation method, it is also possible to obtain a mono-functional oligomer with the three characteristics required within the framework of the invention and mentioned above, and particularly in which the third characteristic is to obtain a mono-functional oligomer with a clearly defined structure.

Controlled radicalar polymerisation is a means of providing a very precise control over radicalar polymerisation since it is based on the formation of active radicalar species starting from compounds with covalent bonds.

Controlled radicalar polymerisation that enables the formation of mono-functional oligomer, satisfies the following reactional schema:

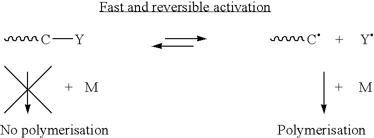

in which M is the mono-functional polymerisable monomer, C is the compound with covalent bonds and Y is a compound forming a thermoreversible bond with the growing chain.

Some of the various known methods of controlled radicalar polymerisation are selected particularly for their ability to produce mono-functional oligomers with the three characteristics required within the framework of the invention, particularly including a perfectly controlled structure.

The various methods preferably selected within the framework of the invention constitute the three groups mentioned below for which a non-limitative illustration is given by mentioning a few cases for the preparation of mono-functional oligomers with an acid function.

First Group

The so-called SFRP or “Stable Free Radical Polymerization” method [See—M. K. Georges, P. N. Veregin, P. M. Kazmaier, G. K. Hamer, Macromolecules, 26, 2987-2988 (1993)]

The so-called INIFERTER or “Initiation Transfer Terminator” method [See—Otsu et al., Macromolecules, 19, 2087 (1989)]

These two methods are based on a homolytic and reversible rupture of a weak covalent bond at a sufficiently high temperature.

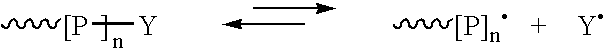

Spontaneous Equilibrium Between Covalent Species and Growing Species

A system based on nitroxyl radicals is used for the SFRP process, while the INIFERTER process uses thiuram disulfides.

Thus, a mono-functional acrylic oligomer with an acid function can be obtained using the SFRP method by radicalar polymerisation of butyl acrylate triggered by azo bis cyanopentanoic acid (ACPA) and controlled by N-tertiobutyl-diethylphosphono-2,2-dimethyl propyl nitroxyl (DEPN).

Similarly, a mono-functional dienic oligomer with an acid function can be obtained using the SFRP method by radicalar polymerisation of butadiene triggered by azo bis cyanopentanoic acid (ACPA) and controlled by 2,2,6,6 tetramethyl-1-piperidinyloxy (TEMPO).

Similarly, a mono-functional styrenic oligomer with an acid function can be obtained using the SFRP method by controlled radicalar polymerisation of styrene triggered by azo bis cyanopentanoic acid (ACPA) and controlled by 2,2,6,6 tetramethyl-1-piperidinyloxy (TEMPO).

Similarly, a mono-functional methacrylic oligomer with an acid function can be obtained using the INIFERTER method by controlled radicalar polymerisation of methyl methyacrylate (MMA) triggered by 4-diethylcarbamoyl sulfonyl methylbenzoic acid.

Similarly, a mono-functional styrenic oligomer with an acid function can be obtained using the INIFERTER method by controlled radicalar polymerisation of styrene triggered by 4-diethylcarbamoyl sulfonyl methylbenzoic acid.

Second Group

ATRP or “Atom Transfer Radical Polymerization” method [See—K. Matyjaszewski, PCT WO96/30421]

This method may be considered as being an extension of the telomerisation reaction by redox catalysis to a polymerisation process.

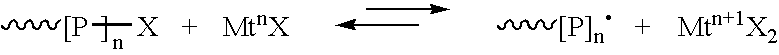

Catalysed Equilibrium Between Covalent Species and Growing Species

This process uses a mono-electric redox process (Mtⁿ/Mtⁿ⁺¹ pair) in which the halogen atom is transferred from the oxidized species Mtⁿ⁺¹X² on the growing chain.

Thus, a mono-functional acrylic oligomer with an acid function can be obtained using the ATRP method by controlled radicalar polymerisation of butyl acrylate triggered by α-bromobutyric acid.

Similarly, a mono-functional methacrylic oligomer with an acid function can be obtained using the ATRP method by controlled radicalar polymerisation of methyl methacrylate triggered by α-bromobutyric acid.

Third Group

RAFT or “Reversible Addition Fragmentation Transfer” method [See—G. Moad, E. Rizzardo, PCT WO96/30421]

MADIX method [See—P. Corpart, D. Charmot, T. Biadatti, S. Zard, D. Michelet, PCT WO98/58974].

These two methods are based on a reversible termination created by degenerative transfer of an atom or group of atoms.

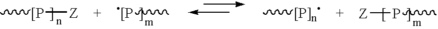

Degenerative Transfer Process of an Atom or Group of Atoms

In the case of the RAFT process, the groups of atoms used are vinylic macro triggers or dithioesters, whereas the MADIX process uses xanthates.

Thus, a mono-functional acrylic oligomer with an acid function can be obtained using the RAFT method, by controlled radicalar polymerisation of butyl acrylate by 4-cyanopentaneic dithiobenzoate acid triggered by 2,2′ azo bis isobutyronitrile (AIBN).

Similarly, a mono-functional vinylic oligomer with an acid function can be obtained using the MADIX method by controlled radicalar polymerisation of vinyl acetate using α(0-ethylxantyl) propionate of tertiobutyl as precursor, followed by a selective hydrolysis of the tertiobutyl group when the polymerisation is complete.

The mono-functional oligomer obtained by controlled radicalar polymerisation has a molar mass comprised between 200 g/mole and 100 000 g/mole, with a polydispersity index \overline{Mw}/\overline{Mn} comprised between 1.1 and 1.4.

The control means used to check the characteristics of the mono-functional oligomers used in the invention, obtained either by radicalar telomerisation or redox catalysis radicalar polymerisation, or by controlled radicalar polymerisation by one of the methods mentioned, are gel-permeation chromatography (GPC), Nuclear Magnetic Resonance (NMR), viscometry or diffusion of light.

When the polyolefin has been functionalised using an appropriate type and a controlled number of reactive or polar functions, and that the mono-functional oligomer that will be used for grafting the functionalised polyolefin comprises a reactive function compatible with the reactive function of the functionalised polyolefin, and is obtained in accordance with the predetermined chain length criteria, with a low polydispersity index and a fully controlled structure, the olefin-based copolymers made affine by grafting according to the invention can be obtained by reaction of at least one mono-functional oligomer according to the invention with the functionalised polyolefin.

The synthesis of grafted olefin-based copolymers according to the invention, made affine by grafting at least one mono-functional oligomer on a functionalised polyolefin can be made as follows in a molten medium:

discontinuously in a mixer or in any other appropriate device, at a temperature that can be comprised between 80° C. and 300° C., by the addition of various components participating in grafting of the functionalised polyolefin;

or continuously in a single screw or dual co-rotating screw extruder comprising a degassing zone, at a temperature comprised between 80° C. and 300° C. and with an average residence time of between 60 and 3600 seconds with a material flow in kg/h and a screw rotation speed in revs/minute adapted to each special case, these parameters being closely dependent on the type of machine used.

At the exit from the mixer or the extruder, the grafted olefin-based copolymers made affine by grafting, are ground into pellets to be stored before use.

However, it is possible that the synthesis of grafted copolymers according to the invention made affine by grafting of at least one mono-functional oligomer on a functionalised polyolefin encompasses the functionalisation of the said polyolefin in a continuous process for obtaining the said grafted copolymers.

According to the invention, the process for obtaining in continuous olefin-based copolymers made affine by grafting with regard to other materials of olefinic or non-olefinic composition with which they are brought into intimate contact, is characterised in that they are produced in a molten medium in an appropriate mixer, for example such as a dual screw extruder, according to the following steps comprising:

in a first zone of the mixer, the functionalisation by grafting of the polyolefin, previously activated or not activated, but in the presence of a radicalar activator, by adding in the molten mass an appropriate quantity of the functional monomer to be grafted, to create a controlled number of reactive functions on the polyolefin;

in another zone of the mixer, the grafting of the functionalised polyolefin by introducing into the molten mass at least one mono-functional oligomer with a predetermined chain length, with a low polydispersity index and with an absolutely controlled structure, for which the reactive function is compatible with functions of the functionalised polyolefin and in a quantity such that the reactive functions of the functionalised polyolefin are grafted;

the reactor temperature being comprised between 80 and 300° C.;

the residence time of the components used in steps a) and b) being comprised between 1 and 6 minutes;

at the exit of the mixer, the copolymers being in the form of pellets, or powders after grinding, possibly cryogenic.

Copolymers based on olefin, grafted according to the invention and obtained according to the continuous process and made affine by said grafting with regard to materials with a non olefinic or olefinic composition, can subsequently be used by extrusion of the mixture, coextrusion, extrusion-coating, lamination coating, or other known means.

The invention will be better understood after reading the illustrative examples, which are in no way limitative.

### EXAMPLE 1

### Functionalisation by Epoxy Grafting of High Density Polyethylene (hdPE), Previously Activated by Ozone, by Glycidyl Methacrylate (GMA)

hdPE, which may indifferently and conventionally be in powder, pellet or chip form, and which is marketed by DSM under the reference Stamylan HD 6621, was activated in a fluidised bed reactor using an air/ozone mixture. The ozone generator was a laboratory ozoniser made by Trailigaz under the reference “minibloc 76”. After a 40-minutes ozonisation time under an air/ozone flow of 1500 l/h, an ozone consumption 18 kg/h, an ozone generator power of 240 W/h, at ambient temperature,. the reactional medium was placed under an air current to eliminate the residual ozone.

Before the grafting itself takes place, the ozonised hdPE and the monomer GMA to be grafted (3% by mass) were previously mixed and were then placed in a drying oven for 5 hours at 55° C. In-mass grafting was done in a dual co-rotating inter-penetrating screw extruder with a length to diameter ratio L/D=36 and provided with a degassing zone. The extrusion was done at 180° C. at a rotation speed of 150 rpm, flow of 5.5 kg/h, and an average residence time of the order of 100 seconds. The grafting rate was determined as follows: the functionalised polymer was purified by dissolution in xylene with reflux for one hour and precipitated in acetone at ambient temperature. After drying, the average grafting ratio determined by infrared with Fourier transform was 2.30% by mass.

### EXAMPLE 2

### Epoxy Functionalisation of High Density Polyethylene (hdPE) by Glycidyl Methacrylate (GMA), Using a Molecular Trigger

hdPE in the form of pellets marketed by DSM under reference Stamylan HD 6621, glycidyl methacrylate (GMA) (3% by mass) and cumyl tertio-butyl peroxide (0.4% by mass) used as the molecular trigger, were added simultaneously into the hopper of a dual co-rotating inter-penetrating screw extruder with a length to diameter ratio L/D=36, provided with a degassing zone. The extrusion was done at 180° C. with a screw rotation speed fixed at 150 rpm, flow 5.5 kg/h, average residence time of the order of 100 seconds. The grafting rate was determined as follows: the functionalised polymer was purified by dissolution in xylene with reflux for one hour and precipitated in acetone at ambient temperature. After drying, the average grafting rate determined by infrared with Fourier transform was of 1.20% by mass.

### EXAMPLE 3

### Synthesis of Mono-Functional Oligomers with a Mass of 10 000 g/mole by Radicalar Telomerisation

A mono-functional methyl methacrylate (MMA) oligomer is prepared by radicalar telomerisation triggered by free radicals derived from thermal decomposition of a trigger. The transfer agent used was thioglycolic acid, and the radicalar trigger was 2,2′ azo bis butyronitryl (AIBN). MMA (40 g, 0.4 mole), thioglycolic acid (0.55 g, 6.10-3 mole) and AIBN (0.64 g, 4.10-3 mole) were added into a flask provided with mechanical stirring and a coolant. The reaction took place in acetonitrile at 70° C. for 10 hours. The reaction product was isolated by evaporation of the reactional medium under a high vacuum. The product was treated as follows, in order to make subsequent analyses or extreme purification: the viscous product obtained was diluted in a small quantity of THF and was then purified by precipitation in pentane, and filtered and dried under a high vacuum. The mono-functional oligomers of MMA were characterised by NMR of the proton and by steric exclusion chromatography using isomolecular methyl polymethacrylate controls. The mono-functional oligomer (acid function) thus prepared had an average molar mass by number (\overline{Mn}) equal to 10 000 g/mole.

### EXAMPLE 4

### Synthesis of Mono-Functional Oligomers with a Mass of 40 000 g/mole by Controlled Radicalar Polymerisation of ATRP Type (Atom Transfer Radical Polymerization)

A mono-functional methacrylic oligomer was prepared by ATRP of methyl methacrylate. α-bromobutyric acid (0.042 g, 25 10-5 mole), methyl methacrylate (MMA) (10 g, 0.1 mole), nickel dibromotriphosphite [NiBr2(PPh3)2] (0.24 g, 5 10-4 mole) were added into toluene in a Schlenk flask. The solution was degassed by bubbling through with nitrogen for 15 minutes. Three <<Pump-Freeze-Thaw>> cycles were then performed in order to eliminate oxygen. The flask was then immersed in a thermostat controlled oil bath at 85° C. for 24 hours. The solvent was then eliminated by evaporation under vacuum. The viscous product obtained was then diluted in a small quantity of THF and then finally purified by precipitation in pentane, filtered and dried under a high vacuum. The mono-functional oligomer of MMA was characterised by RMN of the proton and by steric exclusion chromatography using PMMA isomolecular controls. The mono-functional oligomer (acid function) thus prepared had an average molar mass by number (\overline{Mn}) equal to 40 000 g/mole.

### EXAMPLE 5

### Synthesis of Copolymers Grafted by Grafting Mono-Functional Oligomers Prepared in Example 3 on a Commercial Functionalised Polyolefin

It was added in a Rheomix 600 type discontinuous mixer made by Haake, 5 g of an oligomer of mono-functional acid methyl methacrylate (HOOC—CH2—S—(MMA)₁₀₀—H) with weight (\overline{Mn})=10 000 g/mole, prepared in example 3), and 45 g of glycidyl methacrylate ethylene copolymer (Lotader AX8840) made by Atochem, having the following characteristics:

composition: 92% by weight of ethylene and 8% by weight of glycidyl methacrylate

average molecular weight \overline{Mn}≈20 000 g/mole

fluidity index (MFI at 190° C., 2.16 kg, according to ASTM standard D1238)≈5 g/10 min

The mono-functional oligomer and the commercial copolymer were mixed at 160° C. and at 64 revs/mn. Progress of the grafting reaction was observed by the variation of the resisting torque exerted by the material on the mixer blades. The reaction was stopped when it was observed that the torque had stabilized. After the reaction, the grafted copolymer of type PE-g-PMMA was ground and then used as compatibility agent or adhesive.

### EXAMPLE 6

### Synthesis of Copolymers Grafted in a Reactive Extrusion Step: Functionalisation of the Polyolefin Followed by Grafting of the Mono-Functional Oligomer Prepared in Example 3

Grafted copolymers were obtained in continuous in a dual screw co-rotating inter-penetrating extruder with a length to diameter ratio L/D=36.

The olefinic polymer was functionalised in the first part of the extruder. To achieve this, hdPE marketed by DSM reference Stamylan HD 6621, GMA (3% by mass) and cumyl tertio-butyl peroxide (0.4% by mass) were added simultaneously into the extruder feed hopper. This functionalisation of the polyolefin was done at 180° C. on the first 18D of the extruder. In the second part of the extruder (18D), the mono-functional oligomer with mass 10 000 g/mole (prepared in example 3) is added with 10% by mass (with respect to the polymer mass) directly into the extruder duct through a side feed. The extrusion was done at 180° C. with a screw rotation speed fixed at 100 revs/mn and an average residence time of the order of 200-300 seconds. The rods produced at the exit from the extruder were cooled in water before being broken into pellets and used as compatibility agents or adhesives.

1. Olefin-based copolymers made affine by grafting, characterised in that they are composed of:
i) at least one polyolefin functionalised by means of reactive functions of appropriate type and in controlled number;
ii) and at least one mono-functional type oligomer with a predetermined chain length, with a low polydispersity index and an absolutely controlled structure, which is grafted on the functionalised polyolefin by means of reactive functions, this oligomer being formed from polymerisable monomer(s) and by an approach other than polycondensation.

2. Olefin-based copolymers made affine by grafting with regard to other materials of non olefinic or olefinic composition into which they come into intimate contact, characterised in that:
i) a polyolefin functionalised by means of reactive or polar functions of appropriate type and in controlled number, is used;
ii) the reactive sites of the functionalised polyolefin are made to react at the necessary temperature with at least one mono-functional type oligomer with a predetermined chain length, a low polydispersity index and with an absolutely controlled structure, this oligomer being formed from polymerisable monomer(s) and by an approach other than polycondensation.

3. Olefin-based copolymers made affine by grafting with regard to other materials of non olefinic or olefinic composition into which they come into intimate contact, characterised in that they are obtained according to the process consisting of:
i) using a polyolefin functionalised by means of reactive or polar functions of appropriate type and in controlled number;
ii) making to react the reactive sites of the functionalised polyolefin, at the necessary temperature, with at least one mono-functional type oligomer with a predetermined chain length, a low polydispersity index and with an absolutely controlled structure, this oligomer being formed from polymerisable monomer(s) and by an approach other than polycondensation;
iii) bringing the grafted copolymer into intimate contact with the material of non-olefinic or olefinic composition using an appropriate means.

4. Olefin-based copolymers according to claims 1 or 2 or 3, characterised in that the polyolefin is functionalised by direct grafting using an appropriate monomer with a double bond 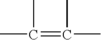
and a reactive function.

5. Olefin-based copolymers according to claim 1 or 2 or 3 or 4, characterised in that the polyolefin is functionalised after prior activation or in the presence of a radicalar trigger.

6. Olefin-based copolymers according to claim 5, characterised in that the previous activation of the functionalised polyolefin is carried out by one of the means belonging to the group composed of ozonisation, ultraviolet radiation, plasma, CORONA effect or irradiation by radiation of electrons or gamma radiation.

7. Olefin-based copolymers according to claim 5, characterised in that the radicalar trigger is chosen from the group composed of bisazoic compounds, peroxides, hydroperoxides, peresters.

8. Olefin-based copolymers according to any one of claims 1 or 2 or 3 or 4 to 7, characterised in that the functionalisation ratio of the functionalised polyolefin is comprised between 0.1 and 60 by weight of monomer contained in the polyolefin.

9. Olefin-based copolymers according to claims 1 or 2 or 3 or 4, characterised in that the polyolefin is functionalised by copolymerisation of an olefinic monomer and at least one monomer carrying a double bond 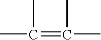
and a reactive function, with or without the presence of comonomer of acrylic ester type.

10. Olefin-based copolymers according to claim 9, characterised in that the functionalisation ratio is adjusted by the content in comonomer, that preferably varies from 3 to 50% by weight.

11. Olefin-based copolymers according to any one of claims 1 or 2 or 3 or 4 to 10, characterised in that the functionalised polyolefin is functionalised by at least one appropriate monomer provided with a double bond 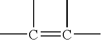
and carrying at least one of the reactive functions belonging to the group composed of the mono, di or tri-acid (—COOH), anhydride (—CO—O—CO—), mono, di or tri-hydroxyl (—OH), epoxy 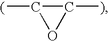
primary or secondary amine (—NH₂), oxazoline 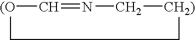
or az-lactone 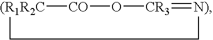
monoisocyanate (—NCO) functions.

12. Olefin-based copolymers according to claim 11, characterised in that the functionalised polyolefin is preferably epoxy functionalised by means of glycidyl methacrylate or glycidyl acrylate.

13. Olefin-based copolymers according to claim 11, characterised in that the functionalised polyolefin is preferably functionalised by means of maleic anhydride, itaconic anhydride, citraconic anhydride, tetrahydrophthalic anhydride, or mixtures of these anhydrides.

14. Olefin-based copolymers according to at least one of claims 1 or 2 or 3 or 4 to 13, characterised in that the graft of the functionalised polyolefin is a mono-functional oligomer, obtained from a polymerisable monomer, having the following three characteristics:
a predetermined chain length,
a very low polydispersity,
a well-defined structure.

15. Olefin-based copolymers according to claim 14, characterised in that the oligomer results from a telomerisation by redox catalysis.

16. Olefin-based copolymers according to claim 14, characterised in that the oligomer results from a radicalar telomerisation.

17. Olefin-based copolymers according to claims 15 or 16, characterised in that the mono-functional oligomer obtained by telomerisation has a molar mass comprised between 200 g/mole and 10 000 g/mole, and a polydispersity index comprised between 1.2 and less than 2, and preferentially between 1.4 and 1.6.

18. Olefin-based copolymers according to claim 14, characterised in that the oligomer results from a controlled radicalar polymerisation.

19. Olefin-based copolymers according to claim 18, characterised in that the oligomer is derived from an SFRP type polymerisation.

20. Olefin-based copolymers according to claim 18, characterised in that the oligomer results from an INIFERTER type polymerisation.

21. Olefin-based copolymers according to claim 18, characterised in that the oligomer results from an ATRP type polymerisation.

22. Olefin-based copolymers according to claim 18, characterised in that the oligomer results from an RAFT type polymerisation.

23. Olefin-based copolymers according to claim 18, characterised in that the oligomer results from a MADIX type polymerisation.

24. Olefin-based copolymers according to at least one of claims 14 to 23, characterised in that the mono-functional oligomer carries a chemical function belonging to the group composed of the mono, di or tri-acid (—COOH), anhydride (—CO—O—CO—), mono, di or tri-hydroxyl (—OH), epoxy 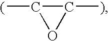
primary or secondary amine (—NH₂), oxazoline 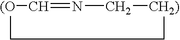
or az-lactone 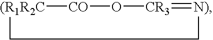
monoisocyanate (N═C═O) functions, capable of reacting with the reactive function of the functionalised polyolefin.

25. Olefin-based copolymers according to at least one of claims 17 to 23, characterised in that the mono-functional oligomer obtained by controlled radicalar polymerisation has a molar mass comprised between 200 g/mole and 100 000 g/mole and a polydispersity index comprised between 1.1 and 1.4.

26. Olefin-based copolymers according to at least one of claims 13 to 24, characterised in that the mono-functional oligomer preferably originates from an acrylic, methacrylic, vinylic, styrenic, dienic structure.

27. Discontinuous synthesis of copolymers according to claims 1 or 2 or 3 and 4 to 26, characterised in that it is carried out in the molten state in an appropriate device, at a temperature comprised between 80° C. and 300° C., by the addition of the functionalised polyolefin and at least one mono-functional oligomer and possibly various components participating in grafting of said functionalised polyolefin.

28. Continuous synthesis of copolymers according to claims 1 or 2 or 3 and 4 to 26, characterised in that it is performed in the molten state in a single screw or dual co-rotating screw extruder, comprising a degassing zone, at a temperature comprised between 80° C. and 300° C. and with an average residence time comprised between 60 and 3600 seconds with a material flow in kg/h and a screw rotation speed in revs/minute adapted, by addition of the functionalised polyolefin, of at least one mono-functional oligomer and possible other components participating in grafting of the said polyolefin.

29. Continuous synthesis of the olefin-based copolymer made affine by grafting with regard to other materials of olefinic or non-olefinic composition with which they are brought into intimate contact, characterised in that it is carried out in a molten medium in an appropriate mixer, preferably in a dual screw extruder provided with a degassing zone, according to the steps comprising:
in a first zone of the mixer, the functionalisation by grafting of the polyolefin, previously activated or not activated, but in the presence of a radicalar activator, by introduction of an appropriate quantity of the functional monomer to be grafted into the molten mass of the polyolefin, to create a controlled number of reactive functions on the polyolefin;
in another zone of the mixer, the grafting of the functionalised polyolefin by adding into the molten mass at least one mono-functional oligomer with a predetermined chain length, a low polydispersity index and an absolutely controlled structure, for which the reactive function is compatible with those of the functionalised polyolefin and in quantity such that the reactive functions of the functionalised polyolefin are grafted;
the temperature of the reactor being comprised between 80 and 300° C.;
the residence time of the components being comprised between 1 and 6 minutes;
at the exit from the mixer, the copolymers being in the form of pellets or powders after grinding, possibly cryogenic.
